(19) United States
(12) Patent Application Publication
(10) Pub. No.: US 2004/0107976 A1
(43) Pub. Date: Jun. 10, 2004

(54) Foot and toe scrubber

(76) Inventors: Sonia Carrine Lawson, Tampa, FL (US); David Dominick Ferrentino, Odessa, FL (US); Stephen Howard Goldstein, Norwalk, CT (US); David Allen Lane, Tampa, FL (US)

Correspondence Address: Sonia Lawson, P.O. Box 320901, Tampa, FL, 33619, US

(21) Appl. No.: 10/639,138

(22) Filed: Aug. 10, 2003

Related U.S. Application Data
(60) Provisional application No. 60/402,897, filed on Aug. 13, 2002.

(51) Int. Cl. B08B 1/00

(52) U.S. Cl. 134/6; 134/42; 601/136

(57) ABSTRACT

This application claims the benefit of U.S. Provisional Application No. 60/402,897, filed Aug. 13, 2002. A foot and toe scrubber has an elongated handle and an elliptical, conical, rectangular, squarish or cylindrical scrubbing element attached at one end of the handle. The scrubbing element is an elliptical, conical, rectangular, squarish or cylindrical foam or sponge material having a plurality of grooves and/or cells providing an overall uneven, irregular surface. The foot and toe scrubber is configured so that the scrubbing element can be applied and moved between and about the toes, as well as other areas of the feet. Application of the scrubber head to, between, around and about the toes and otherwise on the feet is to clean between the toes and other areas of the feet.

### CROSS REFERENCE TO RELATED APPLICATION

This application claims the benefit of U.S. Provisional Application No. 60/402,897, filed Aug. 13, 2002.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Handled foot and toe scrubbers are useful for cleaning between and around the toes and the feet, and the like. Typical scrubbers of this type lack handles and/or elongated handles; are flat, plastic or rubber materials. When applied, such scrubbers require bending or sitting, do not present a uniform cross-section and/or surface or good cleaning edge for between and around the toes and feet. Briefly, such scrubbers lack the elongated handle, soft yet firm and elliptical, conically, cylindrical, squarish or rectangular shaped scrubbing element, applied to a rigged handle, and otherwise lacking the shape and composition needed to quickly and efficiently clean between and around the toes and the feet.

### BRIEF SUMMARY OF THE INVENTION

The present invention provides a handled foot and toe scrubber having an elliptical, conical, cylindrical, squarish or rectangular foam material scrubbing element, provided with a plurality of cutting edges, flutes and/or grooves circumferentially spaced about a solid core.

The present invention makes it less strenuous to wash and cleanse the feet and toes, and makes the foot and toe cleaning process easier and more comfortable. The user does not have to bend, stand on one foot, lean or support himself or resort to other uncomfortable or strenuous activities or uncomfortable positions to clean his feet and toes. The scrubbing element provides a soft, firm and comfortable scrubbing surface for effectively cleaning the feet and toes. The tapered and narrowed section of the handle immediately above the scrubber element provides a comfortable insertion point for the handle, and thus alleviates the need to insert initially the wider scrubbing element between the toes, and likewise alleviates the need to apply inward pressure to the toes to effectively insert the scrubber element for cleaning between the toes. The handle provides an ergonomic and comfortable delivery vehicle for the scrubbing element, allowing the user to remain standing and yet comfortably clean their feet and toes. The handle accommodates various hand sizes, and is configured to provide a strong and controlled application of the scrubber element to the feet and toes.

Further, the foot and toe scrubber can be used for general cleaning of hard to reach places, including, but not limited to, behind, under or on top of heavy appliances, showers, cracks or crevices, boats and cars.

### BRIEF DESCRIPTION OF THE SEVERAL VIEWS OF THE DRAWINGS

Embodiments of the invention have been chosen for purposes of illustration and description, and are shown in the accompanying drawings, wherein:

FIG. 1 is a perspective view of an embodiment of the foot and toe scrubber in accordance with the invention;

FIG. 2 is a perspective view of the handle of the foot and toe scrubber; and

FIG. 3 is a perspective view of the scrubber element; and

FIG. 4 is scrubber element end view of the foot and toe scrubber; and

FIG. 5 is a section view of the scrubber element showing the end of the handle is set back of the end of the scrubbing element by an interval so that the handle substantially supports the scrubbing element without poking through the end of the scrubber element during normal usage.

### DETAILED DESCRIPTION OF THE INVENTION

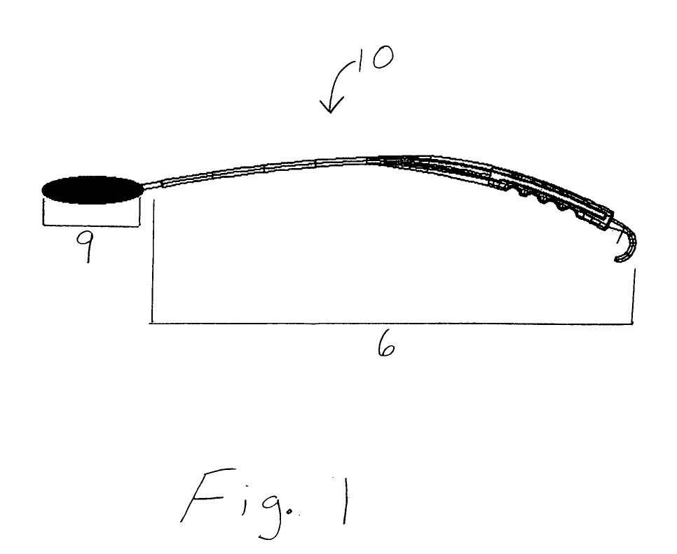

The principles of the invention will be understood by reference to an exemplary implementation shown in FIGS. 1-5.

As shown in FIGS. 1-5, the foot and toe scrubber 10, is suitable for cleaning the feet, including the toes, comprises a handle 6, elongated in a longitudinal direction, and an elliptical, cylindrical, conical, squarish or rectangular scrubbing element 9, co-axially mounted at one end of the handle 6. The element is a foam material 11, in a position longitudinally outward relative to the other end of the handle.

The scrubbing element 9, has a solid central core region 12 (shown in dot-dashed lines in FIG. 5), and an annular region 13, surrounding the core region 12. The annular region 13, includes a plurality of grooves 14, further described below, which extend in the longitudinal direction and define a corresponding plurality of longitudinally extended cutting edges 15, circumferentially spaced at approximately equiangular positions about the annular region 13.

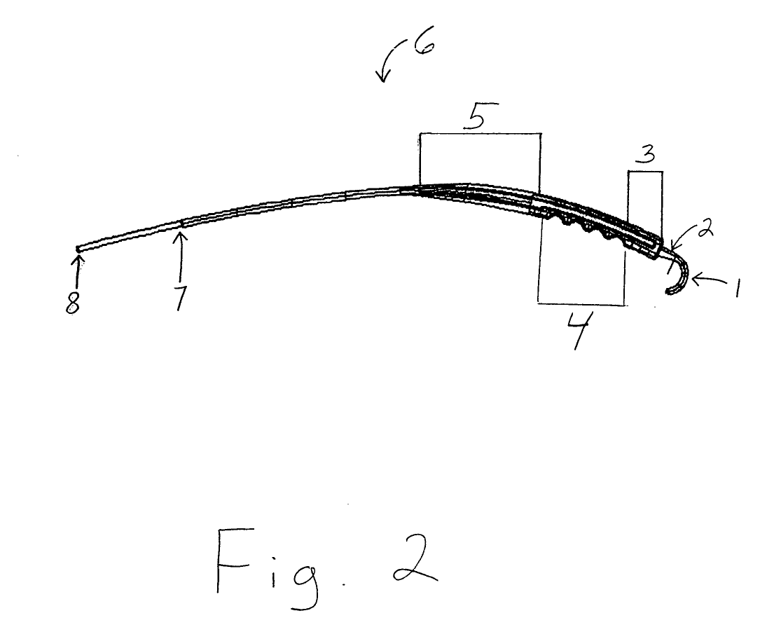

A preferred material for the scrubber element 9 is a polyurethane foam or sponge material. The handle 6, can be plastic, wood or other known scrubber handle construction, including a hook 1, (see FIG. 2) at the non-scrubbing, hand-gripable end of the handle. The hook is used for hanging and other purposes as with conventional scrubbers. The hook connects to the handle through a connecting membrane 2. The ergonomic grip of the handle is comprised of upper 3, middle 4, and lower 5, regions. The scrubber end of handle (the core region) 12 is glued or otherwise affixed into the interior portion of the foam or sponge material 11 (see FIG. 5). The tapered end 8 (see FIGS. 2 and 5), of handle 6, is set back from the end of the scrubbing element 9, by an interval (suitably, approximately 1&¼ inches in a five inch scrubbing element 9 length) so that the handle 6, substantially supports the element 9, without poking through the end of the scrubbing element during normal usage.

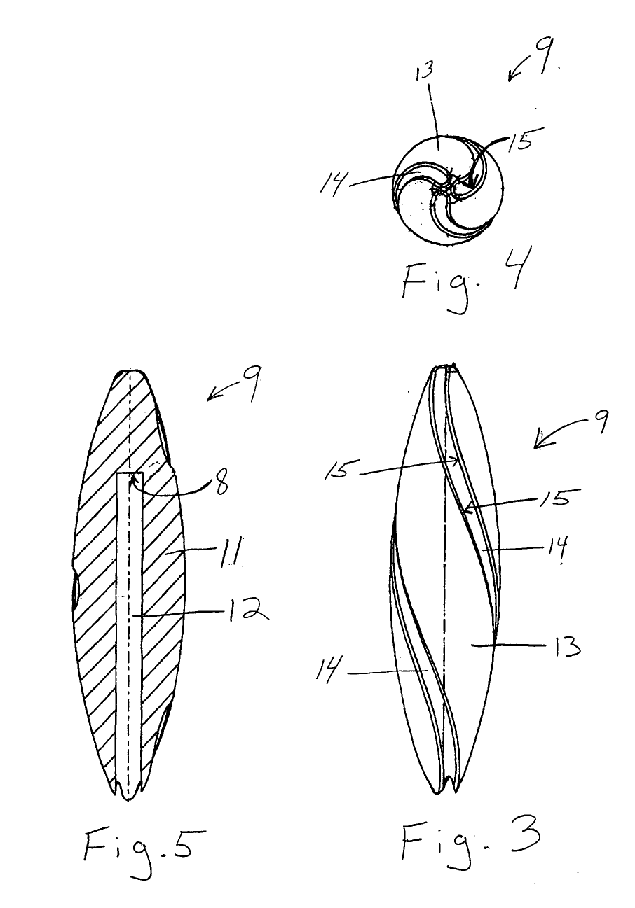

The illustrated embodiment (see FIGS. 3 and 4) has a plurality of spiral groves 14, evenly spaced circumferentially about the scrubbing element 9.

In operation, the section of the handle at which begins a smaller or more narrowed diameter of the handle 7 (see FIG. 2), is inserted between the toes, and the handle 6, then rotated and moved upward to slide and position the scrubbing element between the toes and then rotated and moved up and down in a vertical and/or diagonal motion to provide scrubbing action via the scrubbing element to the area between and around the toes; and may be applied against the foot in general and moved to scrub the foot in an up and down, vertical, rotational, circular or horizontal manner. The scrubbing element 9, contacts and provides scrubbing action to the foot, the toes and between the toes. The spiral cut groves 14, and the resulting cutting edges 15, in the scrubbing element 9, contact and provide scrubbing action to the feet and toes and the area between the toes. The outside diameter of the scrubbing element 9, may be chosen to match the size of different persons and their feet and toes to provide a close contacting fit with the area to be cleansed.

Additional embodiments may include: scrubber elements which are of different shapes or sizes; scrubber heads which are removable and/or replaceable; handle grips of different shapes or configurations; handles which are retractable, extendable or disposable; handles with a hole as opposed to or in addition to a hook for hanging; scrubbing elements made of a different material other than foam or sponge; and scrubber elements connected to or associated with the handle in a manner other than glue.

Those skilled in the art to which the invention relates will appreciate that other substitutions and modifications can be made to describe the embodiment without departing from the spirit and scope of the invention as described by the claims below.

What is claimed is:

1. A method for cleaning between the toes, the method comprising the steps of:
providing a scrubber including a handle elongated in a longitudinal direction and having opposite ends and an elliptical, conical, cylindrical, squarish or rectangular scrubbing element mounted at one end of the handle; the scrubbing element being of a foam, sponge or similar material having an outside perimeter and opposite ends;
inserting the one end of the handle between the toes so that the scrubbing element is placed between and contacts between the toes, and the perimeter of the scrubbing element contacts the surface between, above and around the toes; and
rotating the handle to cause the scrubbing element to provide scrubbing action to the area between and around the surfaces of the toes; and sliding the scrubbing element up and down in a vertical and/or diagonal motion to provide scrubbing action of the scrubbing element to the area between and around the surfaces of the toes.

2. A method as in claim 1, wherein, in the inserting step, the one end of the handle, immediately above the scrubbing element, is inserted so that such part of the handle is inserted between and touches the inner surface of the toes; and wherein, in the rotating and sliding step, the handle is pulled upward so that the scrubbing element is pulled upward and thus slid and inserted between the toes to provide a starting point for moving the scrubbing element in an up and down, vertical, rotating and/or diagonal motion to provide scrubbing action between the toes.

3. A method as in claim 1, wherein, in the providing step, an area of the handle immediately above the scrubber element is indented, tapered or narrowed so the width or circumference of the handle is smaller allowing ease of insertion between the toes.

4. A method for cleaning the feet, the method comprising the steps of: providing a scrubber including a handle elongated in a longitudinal direction and having opposite ends and an elliptical, conical, cylindrical, squarish or rectangular scrubbing element mounted at one end of the handle; the scrubbing element being of a foam, sponge or similar material having an outside perimeter and opposite ends;
applying the scrubbing element in a rotating, circular, and/or up and down and back and forth motion, via the handle, so as to provide scrubbing action of the scrubbing element against the surface of the feet.
